(19) United States
(12) Patent Application Publication
(10) Pub. No.: US 2008/0057859 A1
(43) Pub. Date: Mar. 6, 2008

(54) FILE-LOCATION COORDINATOR AND METHOD OF COORDINATING A LOCATION-BASED FILE

(75) Inventors: Assaf Landschaft, Munich (DE); Laurent Mauguee, Munchen (DE)

Correspondence Address: HITT GAINES, PC;LSI Corporation, PO BOX 832570, RICHARDSON, TX, 75083, US

(73) Assignee: Agere Systems Inc., Allentown, PA (US)

(21) Appl. No.: 11/469,710

(22) Filed: Sep. 1, 2006

(51) Int. Cl. H04H 1/00

(52) U.S. Cl. 455/3.05

(57) ABSTRACT

The present invention provides a file-location coordinator for use with a mobile electronic device. In one embodiment, the file-location coordinator includes a file application unit configured to create a file associated with a location of the mobile electronic device. Additionally, the file-location coordinator also includes a location attachment unit that is coupled to the file application unit and configured to provide a location-based file by attaching a location indicator for the location to the file. In another embodiment, the file-location coordinator further includes a file management unit that is coupled to the location attachment unit and configured to store the location-based file in a file-location database and to retrieve the location-based file based on the location indicator.

### TECHNICAL FIELD OF THE INVENTION

The present invention is directed, in general, to mobile electronic devices and, more specifically, to a file-location coordinator, a method of coordinating a location-based file and communication and global positioning systems employing the coordinator or the method.

### BACKGROUND OF THE INVENTION

Mobile electronic devices provide users with an ever increasing ability to perform many of their recreational and occupational activities without being tied to a specific location. Mobile phones, for example, are being used to accommodate more functions than just communication between users. Many have become portable entertainment centers that allow viewing of news, weather, sports and entertainment video updates. Features such as video and audio on demand allow downloading and playing of video and audio clips that have both sharpness and clarity.

Business users employing Internet-enabled mobile communication devices and personal digital assistants (PDAs) have made the mobile enterprise a viable and cost-effective reality, especially for salespeople and service representatives. Currently, however, the majority of strategic and operational data and company files needed to orchestrate most of business commerce still reside in host systems that are not accessible to mobile users. Expanding technology will allow mobile devices to expand beyond current applications, such as mobile e-mail, and extend mobile capabilities to applications requiring access to company systems and processes.

This capability gives the mobile workforce real-time, continuous access to corporate business information. This functionality will require changes in the form of business files thereby directing them to a format that is more in tune with a mobile enterprise rather than an enterprise that only conducts business from stationary locations or one having a “head office” mentality.

Accordingly, what is needed in the art is an enhanced way to provide files that better accommodate the needs of mobile users.

### SUMMARY OF THE INVENTION

To address the above-discussed deficiencies of the prior art, the present invention provides a file-location coordinator for use with a mobile electronic device. In one embodiment, the file-location coordinator includes a file application unit configured to create a file associated with a location of the mobile electronic device. Additionally, the file-location coordinator also includes a location attachment unit coupled to the file application unit and configured to provide a location-based file by attaching a location indicator for the location to the file. In another embodiment, the file-location coordinator further includes a file management unit coupled to the location attachment unit and configured to store the location-based file in a file-location database and to retrieve the location-based file based on the location indicator.

In another aspect, the present invention provides a method of coordinating a location-based file for use with a mobile electronic device. In one embodiment, the method includes creating a file associated with a location of the mobile electronic device and providing a location-based file by attaching a location designator for the location to the file. In another embodiment, the method also includes storing the location-based file in a file-location database and retrieving the location-based file based on the location indicator.

The present invention also provides, in yet another aspect, a communication system. The communication system includes a mobile communications network employing a cellular grid and a mobile communication device that is coupled to the cellular grid. The communication system also includes a file-location coordinator coupled to the mobile communication device. The file-location coordinator has a file application unit that creates a file associated with a location of the mobile electronic device. The file-location coordinator also has a location attachment unit that is coupled to the file application and provides a location-based file by attaching a location indicator for the location to the file. The file-location coordinator further has a file management unit coupled to the location attachment unit that stores the location-based file in a file-location database and retrieves the location-based file based on the location indicator.

The present invention additionally provides, in still another aspect, a global positioning system (GPS). The GPS includes a satellite positioning network and a mobile electronic device that is coupled to the satellite positioning network. The GPS also includes a file-location coordinator coupled to the mobile electronic device. The file-location coordinator has a file application unit that creates a file associated with a location of the mobile electronic device. The file-location coordinator also has a location attachment unit coupled to the file application unit that provides a location-based file by attaching a location indicator for the location to the file. The file-location coordinator further has a file management unit coupled to the location attachment unit that stores the location-based file in a file-location database and retrieves the location-based file based on the location indicator.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of a communication system constructed in accordance with the principles of the present invention;

FIG. 2 illustrates a system diagram of an embodiment of a global positioning system (GPS) constructed in accordance with the principles of the present invention; and

FIG. 3 illustrates a flow diagram of an embodiment of a method of coordinating a location-based file carried out in accordance with the principles of the present invention.

### DETAILED DESCRIPTION

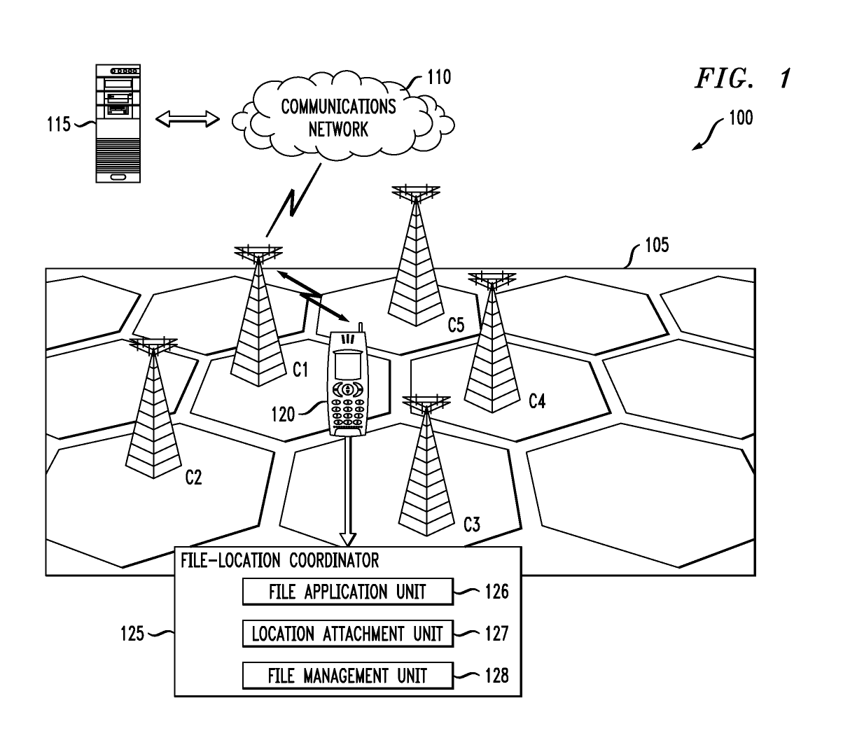

Embodiments of the present invention provide an enhanced capability for users of mobile electronic devices that create or utilize application files and that are also able to determine their location. Referring initially to FIG. 1, illustrated is a system diagram of an embodiment of a communication system, generally designated 100, constructed in accordance with the principles of the present invention.

The communication system 100 includes a cellular grid 105 having a plurality of communication cells C1-C5 that is coupled to a communications network 110. The communications network 110 employs a network server 115 acting as a remote storage device for network or other databases. The communication system 100 also includes a mobile communication device, which is a mobile phone 120 in the illustrated embodiment, coupled to the cellular grid 105. In one embodiment of the present invention, the communication system 100 conforms to the Global System for Mobile Communications/Universal Mobile Telecommunications System (GSM/UMTS) standard.

Each of the plurality of communication cells C1-C5 employs a GSM mast (transmission antenna) wherein each of the GSM masts is associated with a Cell-ID. Gathering of these Cell-IDs along with their accompanying locations into a Cell-ID database allows identification of at least an approximate location for the mobile phone 120 located within a cell that employs its GSM mast for transmission. In the communication system 100, the Cell-ID database may be contained in the mobile phone 120, or alternatively, it may be maintained in the network server 115 and provided routinely to or upon request from the mobile phone 120. The Cell-ID database may be available either publicly or privately.

The location precision of the mobile phone 120, using either GSM or UMTS standards, is generally determined by the dimensions or sizes of each of the communication cells C1-C5. The mobile phone 120 is aware that it is located in the communication cell C1. The mobile phone 120 may also be able to receive signals originating from GSM masts in adjacent communication cells C2, C3, C4 or C5. Therefore, it may be possible to use this connection information to determine or calculate a more precise location of the mobile phone 120 in the communication cell C1. Additionally, a look-up table corresponding to an appropriate Cell-ID or set of Cell-IDs may be employed to determine the location of the mobile phone 120. This look-up table may be available either from the network server 115 or from a storage device that is local to the mobile phone 120.

In the illustrated embodiment, the mobile phone 120 includes a file-location coordinator 125 that is functionally coupled to it. The file-location coordinator 125 includes a file application unit 126 that creates a file associated with a location of the mobile phone 120. The file-location coordinator 125 also includes a location attachment unit 127 that is coupled to the file application unit 126 and provides a location-based file by attaching a location indicator for the location to the file. In the illustrated embodiment, the file-location coordinator 125 further includes a file management unit 128 that is coupled to the location attachment unit 127 and both stores the location-based file in a file-location database and retrieves the location-based file based on the location indicator.

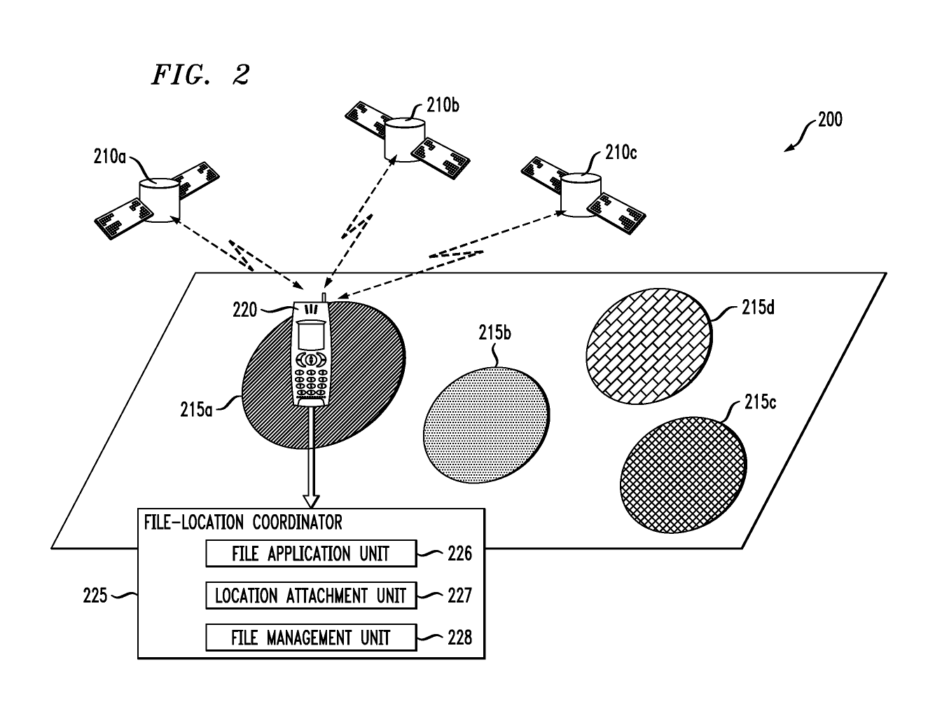

Turning now to FIG. 2, illustrated is a system diagram of an embodiment of a global positioning system (GPS), generally designated 200, constructed in accordance with the principles of the present invention. In the illustrated embodiment, the GPS 200 includes a satellite positioning network employing positioning satellites 210a, 210b, 210c and a mobile electronic device 220, which is also a mobile phone but one having GPS capability, coupled to the positioning satellites 210a, 210b, 210c. The illustrated embodiment of FIG. 2 employs a collection of specific locations 215a-215d corresponding to geographic locations of interest.

As provided in the mobile communication device (i.e., the mobile phone 120) of FIG. 1, the mobile electronic device 220 includes a file-location coordinator 225. In the illustrated embodiment, the file-location coordinator 225 has a file application unit 226, a location attachment unit 227 and a file management unit 228 wherein each of the units perform the same basic functions as indicated for the file-location coordinator 125. A discussion of various attributes of the embodiments of the invention will be presented below that generally may correspond to either the mobile communication system 100 or the GPS 200.

The file may be any file that a user of the mobile devices initially creates, or it may be an existing file that is edited or amended thereby providing a location-based file. The location indicator provides a unique identifier associated with the location of the mobile device during the time that the user is authoring or otherwise working on the file. The location indicator may employ a single indication of the mobile device's location or contain a plurality of location fields associated with the location. This plurality of location fields may be beneficial in coordinating the location-based file by allowing filing or retrieval to occur through a more extensive identification process. Additionally, the plurality of location fields may provide for a plurality of locations that correspond to the same location-based file being used or changed in multiple locations. The location indicator may be stored in meta data associated with the location-based file. Alternatively, the location indicator may be placed in other areas associated with the file as appropriate to the proper filing and retrieval of the location-based file.

Attaching the location indicator may be accomplished in an automatic attachment mode, a user-initiated attachment mode or a combination of the two modes. In one embodiment, the mobile device may be programmed to attach the location indicator based on a preset protocol dictated by an overriding business process or other requirement. In an alternative embodiment, the user may have some or complete discretion in how the location indicator is attached to the file as long as its attachment maintains integrity in indicating the location of the mobile device creating the file.

In one embodiment, the file-location database may employ a remote storage device such as the network server 115 of FIG. 1. The file-location database may be either publicly or privately accessible. In an alternative embodiment, the file-location database may employ a storage device such as a hard drive or flash memory located in the mobile device itself. Additionally, at least portions of the file-location database may be distributed in a plurality of mobile devices wherein communication between the mobile devices allows sharing of the location-based files with others.

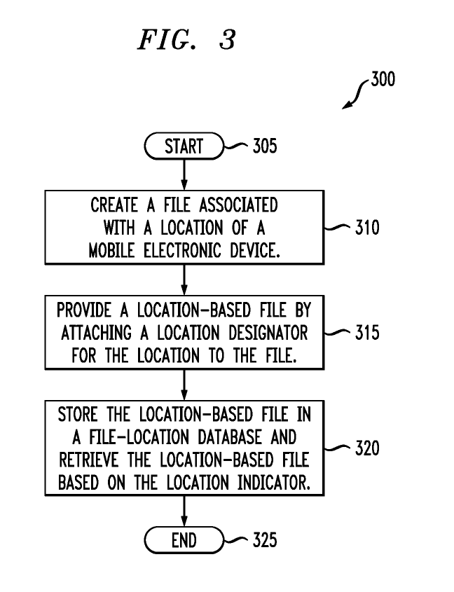

Turning now to FIG. 3, illustrated is a flow diagram of an embodiment of a method of coordinating a location-based file, generally designated 300, carried out in accordance with the principles of the present invention. The method 300 is for use with a mobile electronic device and starts in a step 305. Then, in a step 310, a file associated with a location of the mobile electronic device is created. Creation of the file may be interpreted to mean any action involving the use of the file at the location of the mobile electronic device. In general, this file may be any type of file that a user creates or uses employing the mobile electronic device. A location-based file is provided, in a step 315, by attaching a location designator to the file that corresponds to the location of the mobile electronic device.

In the illustrated embodiment, the location indicator is stored in meta data associated with the file. In one embodiment, the location indicator is attached to the file at some point of the user's association with the file. For example, the location indicator may be attached at the creation of the file. Alternately, the location indicator may be attached when the file is first saved. Additionally, the location indicator may be updated corresponding to a change in the location of the mobile electronic device while the file is still open. These and other options may be employed at the discretion of the user in a user-initiated attachment mode or automatically in an automatic attachment mode.

When the mobile electronic device is employed in a mobile communication network, the location indicator is typically based on a Cell-ID associated with the mobile communication network. Alternatively, the location indicator may be determined by a look-up table corresponding to the Cell-ID. When the mobile electronic device is employed in a GPS, the location indicator is based on a geographic location provided by a satellite positioning network. These two embodiments typically provide location indicators having location accuracies that range from approximate to exacting.

The location-based file is stored in a file-location database wherein it may be retrieved based on its location indicator, in a step 320. The file-location database may employ either a storage device that is remote from the mobile electronic device, a storage device that is local to it or a combination of the two. Retrieval of the location-based file may depend on selection of a location that corresponds to one generated by either the current user or another user and correspond to a current location or another location. The method ends in a step 325.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing a file-location coordinator, a method of coordinating a location-based file and a communication or global positioning system employing the coordinator or the method have been presented. Advantages include the ability to attach an indication of the current location of a mobile device to a file being created, edited or amended on the mobile device. This attachment may typically be accomplished either automatically or manually under the control of attachment guidelines. The resulting location-based files may be stored in or retrieved from a file-location database.

Although the present invention has been described in detail, those skilled in the art should understand that they can make various changes, substitutions and alterations herein without departing from the spirit and scope of the invention in its broadest form.

What is claimed is:

1. a file-location coordinator for use with a mobile electronic device, comprising:
a file application unit configured to create a file associated with a location of said mobile electronic device; and
a location attachment unit coupled to said file application unit and configured to provide a location-based file by attaching a location indicator for said location to said file.

2. The coordinator as recited in claim 1 wherein said location indicator is stored in meta data associated with said file.

3. The coordinator as recited in claim 1 wherein attaching said location indicator employs one selected from the group consisting of:
an automatic attachment mode; and
a user-initiated attachment mode.

4. The coordinator as recited in claim 1 wherein said location indicator is based on a Cell-ID in a mobile communication network.

5. The coordinator as recited in claim 4 wherein said location indicator is determined by a look-up table corresponding to said Cell-ID.

6. The coordinator as recited in claim 1 wherein said location indicator is based on a geographic location provided by a satellite positioning network.

7. The coordinator as recited in claim 1 further comprising a file management unit coupled to said location attachment unit and configured to store said location-based file in a file-location database and to retrieve said location-based file based on said location indicator.

8. The coordinator as recited in claim 7 wherein said file-location database employs one selected from the group consisting of:
a remote storage device; and
a local storage device.

9. A method of coordinating a location-based file for use with a mobile electronic device, comprising:
creating a file associated with a location of said mobile electronic device; and
providing a location-based file by attaching a location designator for said location to said file.

10. The method as recited in claim 9 wherein said location indicator is stored in meta data associated with said file.

11. The method as recited in claim 9 wherein attaching said location indicator employs one selected from the group consisting of:
an automatic attachment mode; and
a user-initiated attachment mode.

12. The method as recited in claim 9 wherein said location indicator is based on a Cell-ID in a mobile communication network.

13. The method as recited in claim 12 wherein said location indicator is determined by a look-up table corresponding to said Cell-ID.

14. The method as recited in claim 9 wherein said location indicator is based on a geographic location provided by a satellite positioning network.

15. The method as recited in claim 9 further comprising storing said location-based file in a file-location database and retrieving said location-based file based on said location indicator.

16. The method as recited in claim 15 wherein said file-location database employs one selected from the group consisting of:
a remote storage device; and
a local storage device.

17. A communication system; comprising:
a mobile communications network employing a cellular grid;
a mobile communication device coupled to said cellular grid; and
a file-location coordinator coupled to said mobile communication device, including:
a file application unit that creates a file associated with a location of said mobile electronic device,
a location attachment unit coupled to said file application unit that provides a location-based file by attaching a location indicator for said location to said file, and
a file management unit coupled to said location attachment unit that stores said location-based file in a file-location database and retrieves said location-based file based on said location indicator.

18. The system as recited in claim 17 wherein said location indicator is based on a Cell-ID in said mobile communications network.

19. The system as recited in claim 18 wherein said location indicator is determined by a look-up table corresponding to said Cell-ID.

20. The system as recited in claim 17 wherein said mobile communications network conforms to a Global System for Mobile Communications/Universal Mobile Telecommunications System (GSM/UMTS) standard.

21. A global positioning system (GPS), comprising:
a satellite positioning network;
a mobile electronic device coupled to said satellite positioning network; and
a file-location coordinator coupled to said mobile electronic device, including:
a file application unit that creates a file associated with a location of said mobile electronic device,
a location attachment unit coupled to said file application unit that provides a location-based file by attaching a location indicator for said location to said file, and
a file management unit coupled to said location attachment unit that stores said location-based file in a file-location database and retrieves said location-based file based on said location indicator.

22. The system as recited in claim 21 wherein said location indicator is based on a geographic location provided by said satellite positioning network.
